(19) United States
(12) Patent Application Publication
(10) Pub. No.: US 2007/0069628 A1
(43) Pub. Date: Mar. 29, 2007

(54) Field emission display device

(75) Inventor: Tai-Cherng Yu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/448,575

(22) Filed: Jun. 7, 2006

(30) Foreign Application Priority Data
Sep. 7, 2005 (CN) 200510037116.3

(51) Int. Cl. H01J 63/04; H01J 1/62

(52) U.S. Cl. 313/495

(57) ABSTRACT

An FED device includes an anode plate, a cathode plate, and spacers. The cathode plate is spaced apart from the anode plate. The spacers maintain an interval between the anode plate and the cathode plate. A number of electron emitters are arranged on the cathode plate. Each of the spacers comprises a central portion, and a number of supporting arms radially extending from the central portion. At least one of the supporting arms has a number of through holes defined therein. Each of the spacers has a first surface in contact with the cathode plate and an opposite second surface in contact with the anode plate. The supporting arms extend from the first surface to the second surface.

### TECHNICAL FIELD

The present invention relates to field emission display (FED) devices, and more particularly to an FED device having a number of spacers.

### BACKGROUND

With the development of information communication, more and more emphasis is being laid on display devices having wide viewing angles, and thin structure with a light weight build. FED devices are devices that enjoy the advantages of allowing for wide viewing angles as well as being thin and light weight.

A typical FED device 10 generally includes an anode plate 11, a cathode plate 12, a gate plate 13, and spacers 14 and 15 as illustrated in FIG. 10. The anode plate 11 and the cathode plate 12 cooperatively define an evacuated interspace region. The spacers 14 are used to maintain the interval between the anode plate 11 and the gate plate 13. The spacers 15 are used to maintain the interval between the cathode plate 12 and the gate plate 13. The anode plate 11 includes an anode electrode 111 facing the cathode plate 12 and a phosphor layer 112. The phosphor layer 112 is formed on the anode electrode 111. The cathode plate 12 includes cathode electrodes 120 facing the anode plate 11 and electron emitters 121. The electron emitters 121 are formed on the cathode electrodes 120. The gate plate 13 includes gate electrodes 130 formed on either a single side of the gate plate 13 or on both sides.

The spacers 14 and 15 play an important role in maintaining the vacuum in the interspace region. However, in use the spacers 14 and 15 tend to bow or even break due to the tremendous pressure difference. Hence, the quality of the FED device 10 is weakened. In addition, it takes a long time to evacuate the FED device 10 during production.

It is therefore desirable to find a new FED device which can overcome the above mentioned problems.

### SUMMARY

In a preferred embodiment, an FED device includes an anode plate, a cathode plate, and spacers. The cathode plate is spaced apart from the anode plate. The spacers maintain the interval between the anode plate and the cathode plate. A number of electron emitters are arranged on the cathode plate. Each of the spacers comprises a central portion, and a number of supporting arms radially extending from the central portion. At least one of the supporting arms has a number of through holes defined therein. Each of the spacers has a first surface in contact with the cathode plate and an opposite second surface in contact with the anode plate. The supporting arms extend from the first surface to the second surface.

Other advantages and novel features will become more apparent from the following detailed description of the present FED device, when taken in conjunction with the accompanying drawings.

### BRIEF DESCRIPTION OF THE DRAWINGS

Many aspects of the FED device can be better understood with reference to the following drawings. The components in the drawings are not necessarily drawn to scale, the emphasis instead being placed upon clearly illustrating the principles of the present invention.

FIG. 1 is a schematic exploded perspective view of an FED device, in accordance with a first embodiment;

FIG. 2 is a schematic, enlarged isometric view of a spacer in accordance with a first embodiment;

FIG. 3 is a cross-sectional view of the spacer shown in FIG. 2, taken along the line IV-IV thereof,

FIG. 4 is a schematic exploded perspective view of an FED device, in accordance with a second embodiment; and

FIG. 5 is a schematic exploded perspective view of an FED device, in accordance with a third embodiment.

FIG. 6 is a schematic exploded perspective view of an FED device, in accordance with a fourth embodiment.

FIG. 7 is a schematic, enlarged isometric view of a spacer in accordance with a fourth embodiment;

FIG. 8 is a schematic exploded perspective view of an FED device, in accordance with a fifth embodiment.

FIG. 9 is a schematic exploded perspective view of an FED device, in accordance with a sixth embodiment.

FIG. 10 is a schematic exploded perspective view of a typical FED device;

Corresponding reference characters indicate corresponding parts throughout the drawing. The exemplifications set out herein illustrate at least one preferred embodiment of the invention, in one form, and such exemplifications are not to be construed as limiting the scope of the invention in any manner.

### DETAILED DESCRIPTION OF THE EMBODIMENTS

Reference will now be made to the drawings to describe the preferred embodiments of the present FED device in detail.

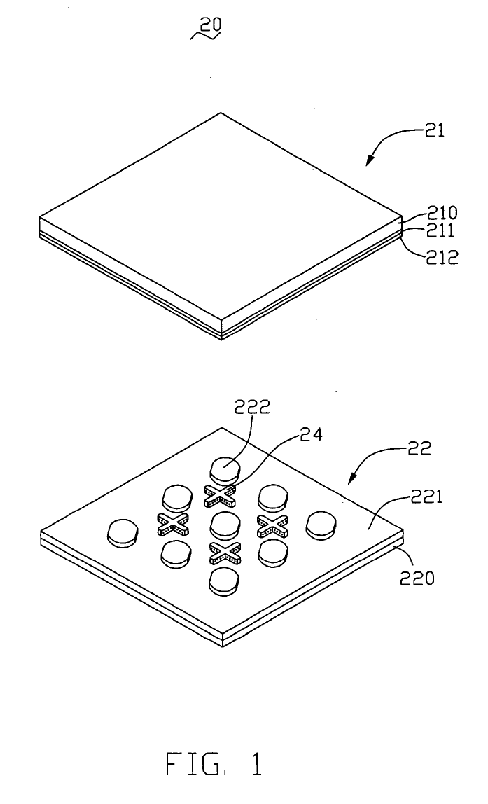

Referring to FIG. 1, an FED device 20 is shown in accordance with a first embodiment. The FED device 20 includes an anode plate 21, a cathode plate 22 and spacers 24. The cathode plate 22 is spaced apart from the anode plate 21. The cathode plate 22 is generally oriented in parallel with the anode plate 21. The spacers 24 maintain the interval between the anode plate 21 and the cathode plate 22 to be constant.

The anode plate 21 includes a front substrate 210, an anode electrode 211, and a phosphor layer 212. The anode electrode 211 is formed on the front substrate 210 facing the cathode plate 22. The phosphor layer 212 is formed on the anode electrode 211. The front substrate 210 is generally made of glass. The anode electrode 211 is an indium-tin oxide film.

The cathode plate 22 includes a rear substrate 220, a cathode electrode 221 and electron emitters 222. The cathode electrode 221 is formed on the rear substrate 220 facing the anode plate 21. The electron emitters 222 are formed on the cathode electrode 221. The rear substrate 220 is made of glass. The electron emitters 222 are arranged in a matrix on the cathode plate 221. The electron emitters 222 can be selected from the group consisting of metal micro-tips, diamond, carbon nanotubes and silicon nanolines.

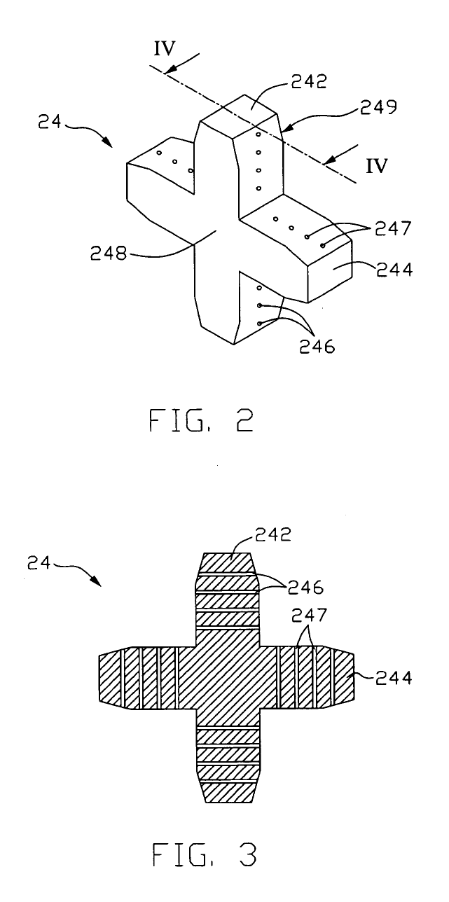

The spacers 24 are arranged in a matrix. Referring to FIGS. 2 and 3, each spacer 24 has a first side 248 and an opposing second side 249. Each of the first side 248 contacts the anode plate 21 and each second side 249 contacts the cathode plate 22. The spacer 24 includes a first wall 242 and a second wall 244, which together form a cross structure. The first wall 242 crosses the second wall 244 perpendicularly. The first wall 242 and the second wall 244 both have two opposite tapered ends.

The first wall 242 defines a number of first through holes 246 arranged separated by an equal distance therein. The second wall 244 defines a number of second through holes 247 arranged separated by an equal distance therein. The first through holes 246 and the second through holes extend in a direction parallel to the cathode plate 22. The depths of the first through holes 246 near two ends of the first wall 242 are less than those of the other first through holes 246. The depths of the second through holes 247 near two ends of the second wall 244 are less than those of the other second through holes 247.

The spacer 24 is made of a material selected from the group consisting of glass, ceramics and metal.

Due to the cross structure of the spacer 24, the contact area between the spacer 24 and the anode plate 21 is increased. Due to the cross structure, the contact area between the spacer 24 and the cathode plate 22 is also increased. Therefore, the spacer 24 has a high supporting strength and can better withstand the pressure difference between the inside and outside of the FED device 20. In addition, due to the first through holes 246 and the second through holes 247 in the spacer 24, the rate of evacuation of the FED device can be increased. Thus it takes less time to evacuate the FED device 20 in manufacturing.

It should be noted that the spacer 24 can be, for example, T-shaped or L-shaped. An angle formed by the first wall 242 and the second wall 244 can be larger than 0 degrees and less than 90 degrees.

It should be further noted that the through holes can be defined either only in the first wall 242 or only in the second wall 244.

It should be still further noted that spacers 24 can be arranged in other forms to keep the anode plate 21 and the cathode plate 22 under even strain.

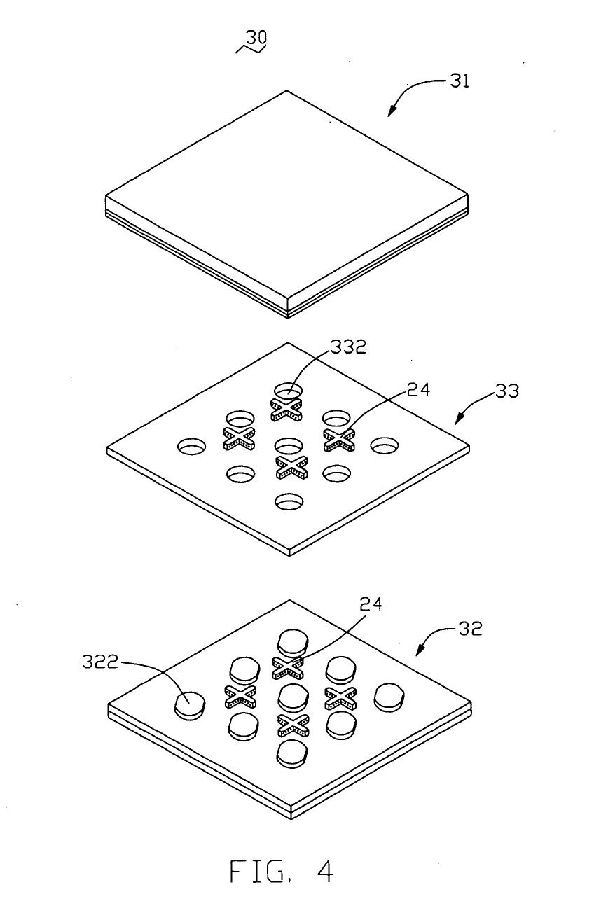

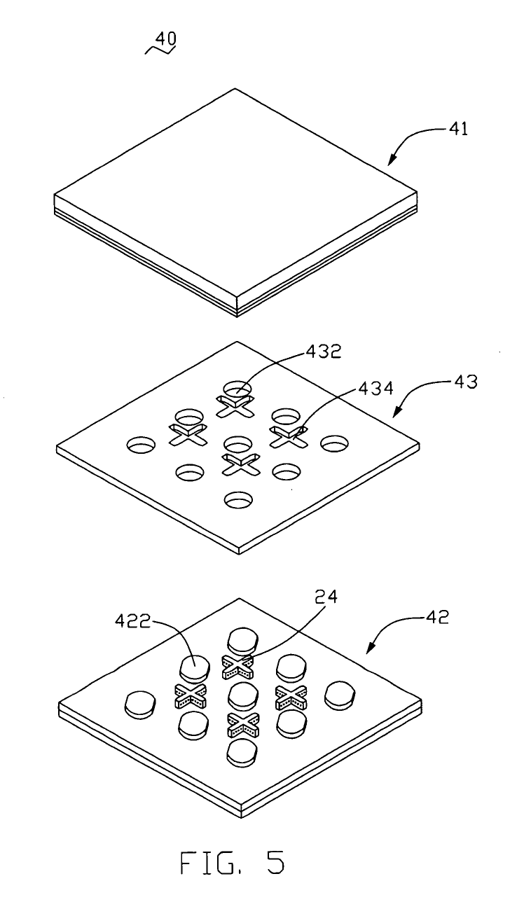

Referring to FIG. 4, an FED device 30 is shown in accordance with a second embodiment. The FED device 30 includes an anode plate 31, a cathode plate 32, a gate plate 33, and spacers 24. The cathode plate 32 is spaced apart from and in parallel with the anode plate 31. The gate plate 33 is sandwiched between the anode plate 31 and the cathode plate 32. The gate plate 33 is parallel with the anode plate 31. The spacers 24 maintain a constant interval between the anode plate 31, the gate plate 33 and the cathode plate 32.

The anode plate 31 and the cathode plate 32 have the same respective structure as the anode plate 21 and the cathode plate 22 in the first embodiment. The gate plate 33 has a number of apertures 332 defined therein. The apertures 332 are positioned corresponding to the position of the electron emitters 322 so that electrons from the electron emitters 322 can pass through the apertures 322.

It should be noted that the gate plate 33 can be formed directly on the anode plate 31. In this case, the spacers 24 would only be arranged between the anode plate 31 and the gate plate 33.

Also, it should be noted that the gate plate 33 can be formed directly on the cathode plate 32. In this case, the spacers 24 would only be arranged between the cathode plate and the gate plate 33.

Referring to FIG. 5, an FED device 40 is shown in accordance with a third embodiment. The FED device 40 includes an anode plate 41, a cathode plate 42, a gate plate 43, and spacers 24. The cathode plate 42 contacts with the gate plate 43. The spacers 24 maintain a constant interval between the anode plate 41 and the cathode plate 42, thereby also maintaining the interval between the anode plate 41 and the gate plate 43.

The anode plate 41 and the cathode plate 42 have the same respective structures as the anode plate 21 and the cathode plate 22 in the first embodiment.

The gate plate 43 has a number of apertures 432 and openings 434 defined therein. The apertures 432 are positioned corresponding to the position of the electron emitters 422 so that electrons from the electron emitters 422 can pass through the apertures 432. The openings 434 have the same shape as the spacers 24 and are positioned corresponding to the position of the spacers 24. Therefore, the spacers 24 pass through the openings 434 and contact with the anode plate 41.

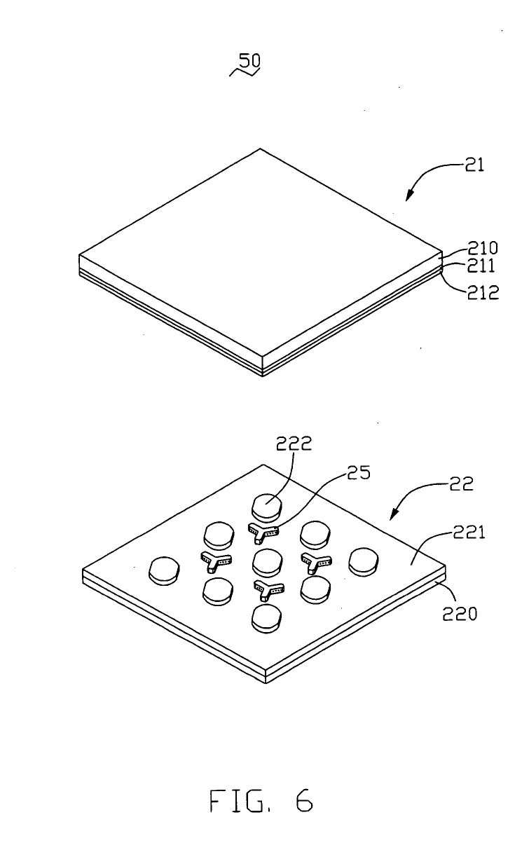

Referring to FIG. 6, an FED device 50 is shown in accordance with a fourth embodiment. The FED device 50 is similar to the FED device 20 in FIG. 1, but incorporating the spacers 25 instead of the spacers 24. The FED device 50 includes an anode plate 21, a cathode plate 22 and spacers 25. One surface of each spacer 25 contacts with the anode plate 21, the other opposite surface of each spacer 25 contacts with the cathode plate 22.

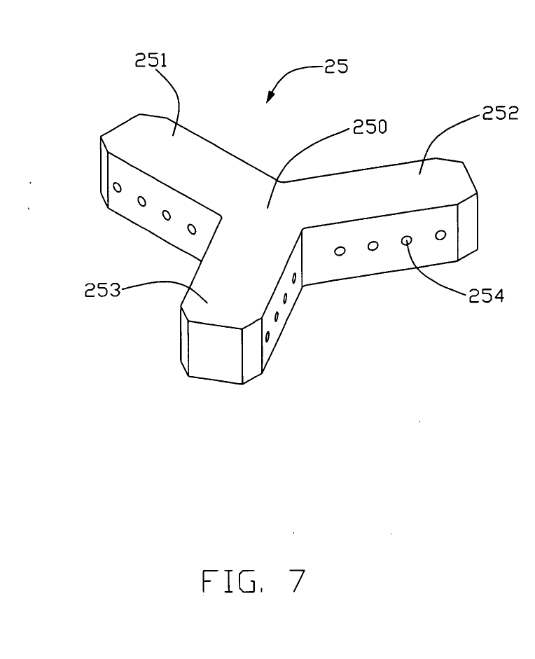

Referring to FIGS. 6 and 7, each spacer 25 has a central portion 250. Three supporting arms 251, 252, 253 extend radially from the central portion. The arms 251, 252, 253 all have tapered ends. The arms 251, 252, 253 define a number of through holes 254 arranged equidistantly therein. The through holes 254 extend in a direction parallel to the cathode plate 22.

It should be noted that the spacer can have more than three arms extending radially from the central portion. For example, a spacer 24 having four arms is illustrated in FIGS. 2 and 3.

It should be further noted that the arms can be arranged in a manner so as to be separated by equal angles or by non-equal angles extending radially from the central portion.

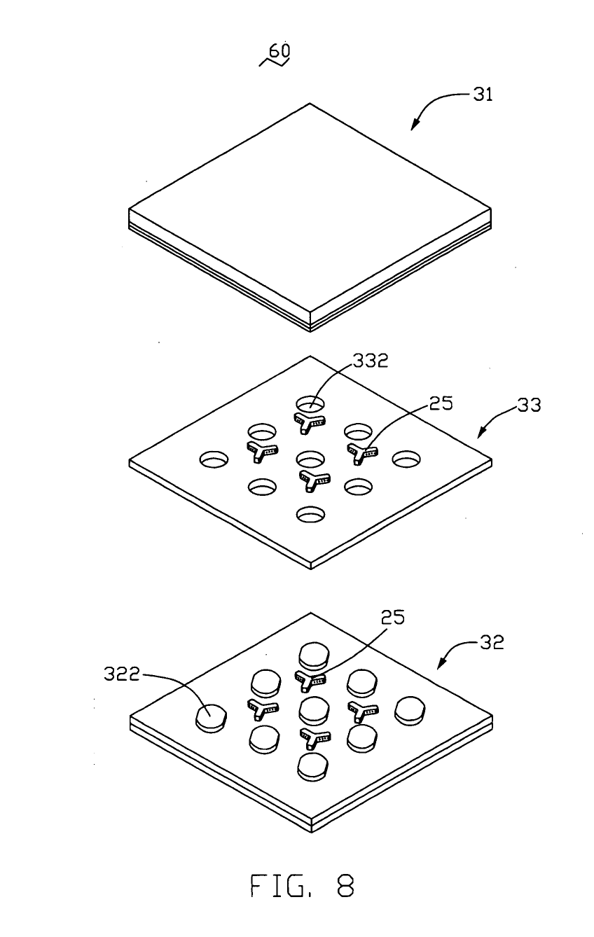

Referring to FIG. 8, an FED device 60 is shown in accordance with a fifth embodiment. The FED device 60 is similar to the FED device 30 in FIG. 4, but incorporating the spacers 25 instead of the spacers 24.

It should be noted that the gate plate 33 can be formed directly on the anode plate 31. In this case, the spacers 25 would only be arranged between the cathode plate 32 and the gate plate 33.

Also, it should be noted that the gate plate 33 can be formed directly on the cathode plate 32. In this case, the spacers 25 would only be arranged between the anode plate 31 and the gate plate 33.

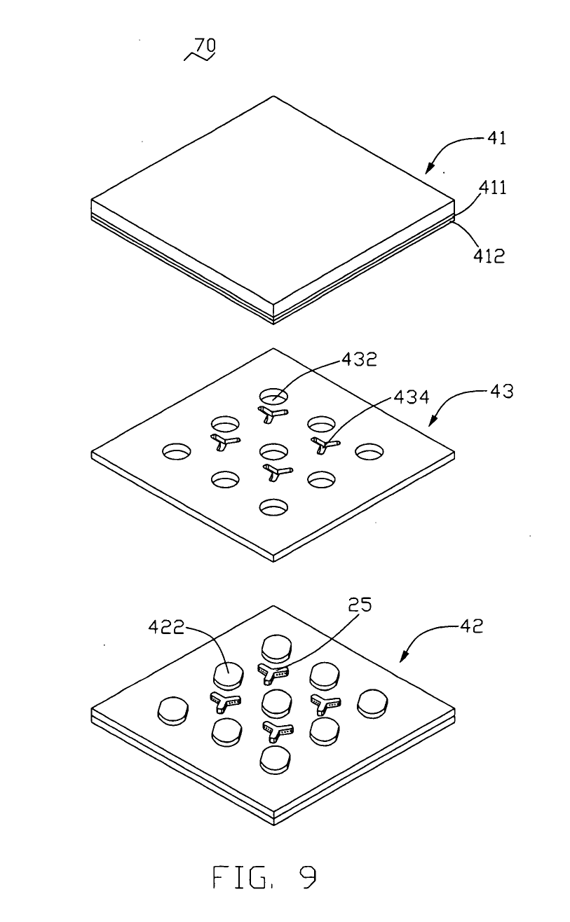

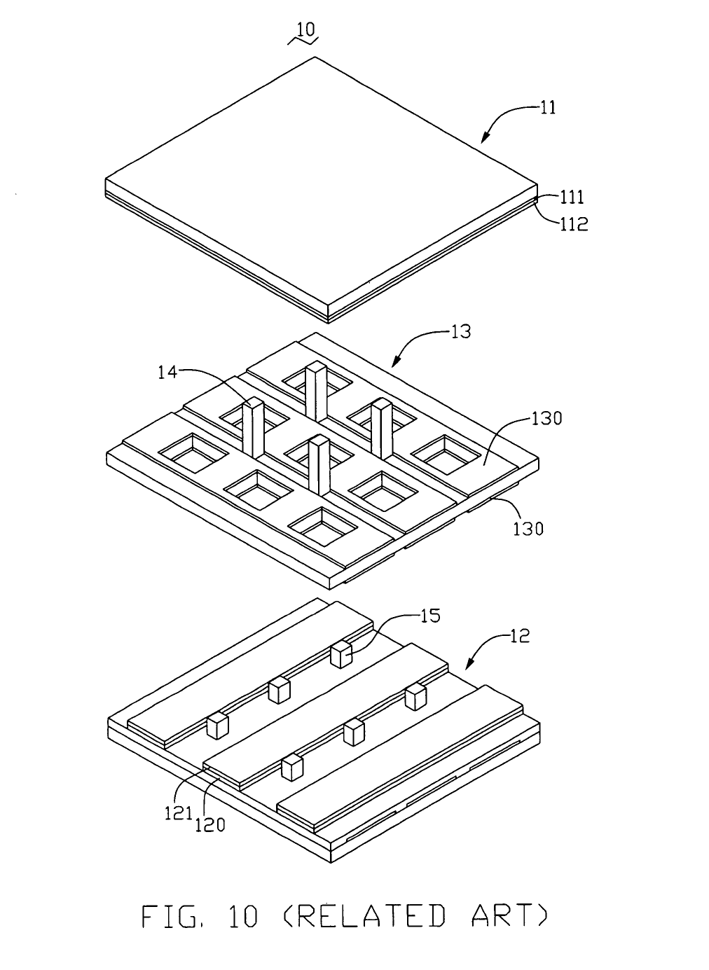

Referring to FIG. 9, an FED device 70 is shown in accordance with a sixth embodiment. The FED device 70 is similar to the FED device 40 in FIG. 5, but incorporating the spacers 25 instead of the spacers 24.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A field emission display device, comprising:
an anode plate;
a cathode plate with a plurality of electron emitters arranged thereon opposite to the anode plate, wherein the cathode plate and the anode plate define an interval therebetween; and
a plurality of spacers arranged between the cathode plate and the anode plate, the spacers being configured for supporting and maintaining the interval between the anode plate and the cathode plate, each of the spacers comprising:
a central portion, and
a plurality of supporting arms radially extending from the central portion, wherein each of the spacers has a first surface in contact with the cathode plate and an opposite second surface in contact with the anode plate, at least one of the supporting arms having a plurality of through holes defined therein, the supporting arms extending from the first surface to the second surface.

2. The field emission display device as recited in claim 1, wherein the through holes extend in a direction parallel to the cathode plate.

3. The field emission display device as recited in claim 1, wherein the supporting arms are separated by equal angles and extend radially from the central portion.

4. The field emission display device as recited in claim 1, further comprising a gate plate arranged between the anode plate and the cathode plate, the spacers extending through the gate plate.

5. A field emission display device, comprising:
an anode plate;
a cathode plate with a plurality of electron emitters arranged thereon opposite to the anode plate, wherein the cathode plate and the anode plate define an interval therebetween;
a gate plate arranged between the anode plate and the cathode plate; and
a plurality of spacers arranged between the cathode plate and the anode plate, the spacers being configured for supporting and maintaining the interval between the anode plate and the cathode plate, each of the spacers comprising:
a central portion, and
a plurality of supporting arms radially extending from the central portion, wherein each of the spacers has one surface in contact with the gate plate and other surface in contact with either of the cathode plate and the anode plate, at least one of the supporting arms having a plurality of through holes defined therein, the supporting arms extending from the first surface to the second surface.

6. The field emission display device as recited in claim 5, wherein the through holes extend in a direction parallel to the cathode plate.

7. The field emission display device as recited in claim 5, wherein the supporting arms are separated by equal angles and extend radially from the central portion.

8. A field emission display device, comprising:
an anode plate;
a cathode plate with a plurality of electron emitters arranged thereon spaced apart from the anode plate, wherein the cathode plate and the anode plate define an interval therebetween; and
a plurality of spacers arranged between the anode plate and the cathode plate, the spacers being configured for maintaining the interval between the anode plate and the cathode plate, each of the spacers comprising:
a first wall having a plurality of first through holes defined therein, and
a second wall intersecting the first wall.

9. The field emission display device as recited in claim 8, wherein the second wall has a plurality of through holes defined therein.

10. The field emission display device as recited in claim 8, wherein the first wall has two opposite tapered ends.

11. The field emission display device as recited in claim 8, wherein the second wall has two opposite tapered ends.

12. The field emission display device as recited in claim 8, wherein a shape of the spacer is selected from the group including T-shaped, L-shaped, and cross-shaped.

13. The field emission display device as recited in claim 8, wherein an angle formed between the first wall and the second wall of the spacers is larger than 0 degrees and less than 90 degrees.

14. The field emission display device as recited in claim 8, wherein an angle formed between the first wall and the second wall of the spacers is equal to 90 degrees.

15. The field emission display device as recited in claim 8, wherein the cathode plate comprises a rear substrate, a cathode electrode formed on the rear substrate facing the anode plate with the electron emitters formed on the cathode electrode.

16. The field emission display device as recited in claim 8, further comprising a gate plate arranged between the anode plate and the cathode plate.

17. The field emission display device as recited in claim 16, wherein the spacers are arranged between the anode plate and the gate plate.

18. The field emission display device as recited in claim 16, wherein the spacers are arranged between the cathode plate and the gate plate.

19. The field emission display device as recited in claim 16, wherein the gate plate has a plurality of openings with the spacers extending therethrough.
